(19) United States
(12) Patent Application Publication
(10) Pub. No.: US 2018/0191038 A1
(43) Pub. Date: Jul. 5, 2018

(54) BATTERY PACK AND BATTERY PACK SYSTEM

(71) Applicant: Microvast Power Systems Co., Ltd., Huzhou City, Zhejiang Province (CN)

(72) Inventors: XIANG LI, Huzhou City, Zhejiang Province (CN); ZHIMING TONG, Huzhou City, Zhejiang Province (CN); HUI LI, Huzhou City, Zhejiang Province (CN); LINGYAN FU, Huzhou City, Zhejiang Province (CN)

(21) Appl. No.: 15/741,272

(22) PCT Filed: Jul. 20, 2015
(86) PCT No.: PCT/CN2015/084457

§ 371 Date: Dec. 31, 2017

(51) Int. Cl. H01M 10/613; H01M 10/0525; H01M 10/625; H01M 10/6552; H01M 10/6569; H01M 2/10; H01M 2/12; H01M 10/6567

(52) U.S. Cl. CPC H01M 10/613; H01M 10/0525; H01M 10/625; H01M 10/6552; H01M 2220/20; H01M 2/1077; H01M 2/1223; H01M 10/6567; H01M 2200/10; H01M 10/6569

(57) ABSTRACT

A battery pack and a battery pack system are provided. The battery pack includes a battery box and a battery module. The battery module is disposed in the battery box. The battery module consists of a plurality of battery cells. The battery box is further filled with a sealing liquid. The battery module is at least partially immersed in the sealing liquid. At least one cooling pipe is disposed in the battery box. At least a portion of the cooling pipe is configured to melt and form a breach after reaching a preset temperature. The cooling pipe is filled with a coolant. The vaporization latent heat of the coolant is higher or equal to the heat capacity or the vaporization latent heat of the sealing liquid.

### TECHNICAL FIELD

The present application relates to a battery pack including lithium ion battery and a battery pack system having the battery pack.

### BACKGROUND

The power system of an energy storage/electric vehicle consists of a plurality of battery modules, and the battery module consists of a plurality of battery cells. The battery cells in the battery module are arranged very closely in order to pursuit the energy density of the battery module. As a result, it is easy to accumulate heat in the battery module, especially in the middle of the battery module, where the temperature is generally higher than other positions. Once the heat of particular battery cells in the battery module is accumulated to a certain extent, it may lead to thermal runaway. Further, the thermal runaway will propagate in the battery module to cause the temperature of other normal battery cells to rise rapidly, thereby leading to thermal runaway of the whole battery module. This is extremely dangerous, especially in the hermetically-sealed battery box.

Chinese application No. CN201280043177.9, entitled “fire extinguishing apparatus for battery pack” discloses an apparatus for extinguishing a battery-pack fire upon the occurrence of a fire in the battery pack. The fire extinguishing apparatus includes a fire detecting sensor for sensing whether or not the battery pack is on fire; a fire extinguishing agent storage tank which stores a fire extinguishing agent in an interior space therein; and a control unit which causes the fire extinguishing agent in the fire extinguishing agent storage tank to be injected into the battery pack upon the sensing of the occurrence of a fire by the fire detecting sensor.

The fire detecting sensor in the application is used for sensing whether or not the battery pack is on fire, it is proved that the fire extinguishing apparatus starts work only when open flame occurs. In fact, the early stage of thermal runaway shows with smoking and temperature rising of the battery cell having obvious symptom. Once thermal runaway occurs in a particular battery cell, it will generate heat continuously to heat up neighboring battery cells above the critical temperature of thermal runaway, to thereby bring these normal battery cells into thermal runaway. This phenomenon will propagate rapidly and generate heat continuously, until other neighboring battery cells are heated up to the state of thermal runaway.

Chinese application No. CN201410186474.X, entitled “high water-resistant thermal-insulation battery box for electric vehicle” discloses a battery box which includes a sealed box, a plurality of battery cells in the box and a radiator arranged in the box and connected with the battery cells. Each battery cell is provided with a heating device, and a controller connected with the heating devices through a control circuit is arranged in the box. It is also provided with hollow radiating panels for heat radiation of each battery cell, so that uniform heat radiation of the battery cells is guaranteed, and heat dissipation efficiency is improved. The technical solution of the application can solve the problem of temperature uniformity among the battery cells during normal operation of the battery. However, due to the thermal conduction by the radiating panels, once thermal runaway happens in a particular battery cell, the heat will be transferred to the other normal battery cells rapidly to cause propagation of thermal runaway.

US publication No. US20100136391A1, entitled “active thermal runaway mitigation system for use within a battery pack” discloses a battery pack including a battery thermal runaway control system. The control system includes at least one fluid-containing conduit in proximity to the cells within the battery pack. The conduit includes a plurality of breach points in proximity to the subset of cells, where each breach point is configured to form a breach at a preset temperature that is lower than the melting temperature of the conduit. Once a breach is formed, the fluid contained within the conduit is discharged through the breach to cool the cells. The technical solution of the application can realize a certain temperature control when thermal runaway occurs in the cells. However, due to exposure of the cells in the air, when thermal runaway occurs in a particular cell, it may firstly cause open flames and occurrence of naked fire, and all of the combustible materials in the cells will react fully with the oxygen to generate a large amount of heat. Even if the fluid contained within the conduit is discharged through the breach of the conduit, the large amount of generated heat requires a large amount of the fluid, which seriously affects the thermal control effect. In the meantime, the flame produced by the naked fire may cause the neighboring cells to be ignited rapidly, resulting in happening of further thermal runaway.

Chinese application No. CN201220017950.1, entitled “safety battery pack” discloses a method of immersing battery cells in insulation sealing liquid. The method isolates the battery cells from the air. When thermal runaway occurs in a particular battery cell, the combustible gas ejected out from the battery cell firstly encounters the sealing liquid and is cooled down to thereby prevent occurrence of open flame and naked fire. A large amount of the combustible material in the battery cell is released in the form of smoke, greatly reducing the total amount of heat. Nevertheless, the heat generated by the battery cell in thermal runaway is still considerable, which may heat up the temperature at 400 Celsius degree or higher. For considering the limitation of weight and volume, the quantity of the insulation sealing liquid in each battery pack is usually very limited, it is hard to fully absorb or take away the generated heat, and it is unable to realize the function of controlling the battery temperature under the thermal runaway point. Thus, the heat will heat up the neighboring cells to above the thermal runaway point to induce thermal runaway of more battery cells, to cause happening of accelerated thermal runaway in the entire battery pack or battery system and finally lead to crashing of the battery system.

### SUMMARY

The object of the present application is to provide a battery pack, which includes a battery box and a battery module. The battery module is disposed in the battery box. The battery module consists of a plurality of battery cells. The battery box is further filled with a sealing liquid, and the battery module is at least partially immersed in the sealing liquid. At least one cooling pipe is disposed in the battery box, and at least a portion of the cooling pipe is configured to melt and form a breach after reaching a preset temperature. The cooling pipe is filled with a coolant, and the vaporization latent heat of the coolant is higher or equal to the heat capacity or the vaporization latent heat of the sealing liquid.

By immersing the battery module in the sealing liquid, it can avoid damage of external moisture to the battery module and prolong the service life of the battery module; further, the sealing liquid helps to dissipate heat from the battery module to maintain uniform temperature inside the battery module. Once a thermal runaway happens to the battery cells, the sealing liquid can effectively isolate air to avoid open flame and even fire, thereby greatly reducing the total heat generation.

The cooling pipe is disposed in the battery box, and the coolant is filled in the cooling pipe, which is helpful for dissipating heat from the battery module. The cooling pipe has at least a portion which is configured to melt and form a breach after reaching a preset temperature, such that a large amount of the coolant is discharged out rapidly from the breach of the cooling pipe and absorbs heat by temperature rise and/or phase change of the coolant, to control the temperature of the battery module under the thermal runaway temperature of the battery pack and effectively inhibit propagation of thermal runaway.

According to the object of the present application, the vaporization latent heat of the coolant is higher or equal to the heat capacity or the vaporization latent heat of the sealing liquid. Therefore, when thermal runaway occurs in a particular battery cell of the battery pack and the temperature reaches the vaporization temperature of the coolant, the coolant can absorb a large amount of heat by phase change to rapidly reduce the temperature under the thermal runaway temperature point after the thermal runaway occurs, to avoid further propagation of thermal runaway and accordingly prevent the entire battery system from breakdown.

Preferably, the preset temperature is lower than the thermal runaway temperature of the battery module.

According to the normal operation temperature range of the battery pack, the preset temperature is generally in the range from 70 to 150 Celsius degree; preferably, the preset temperature is in the range from 70 to 130 Celsius degree; more preferably, the preset temperature is 100 Celsius degree, or the preset temperature is 130 Celsius degree.

Under normal operation conditions of the battery module, the cooling pipe is used for cooling the battery module. When the battery module reaches the preset temperature due to thermal runaway at local areas, the cooling pipe is melt and forms a breach, and the coolant is discharged out from the breach of the cooling pipe. The coolant undergoes phase change and absorbs a large amount of heat, to effectively control propagation of thermal runaway.

According to an embodiment of the present application, a material of the portion of the cooling pipe, configured to melt and form a breach, is selected from an alloy with low melting point or a polymer with low melting point, wherein low melting point in the present application generally means a melting point below 200 Celsius degree.

In general, the above-mentioned polymer with low melting point is at least one selected from POE (copolymer of ethylene and butylene), EVA (copolymer of ethylene and acetic acid), ABS (acrylonitrile-butadiene-styrene copolymer), PU (polyurethane), PA (polyamide) and CPVC (chlorinated polyvinyl chloride).

The alloy with low melting point is at least one selected from Ga, In, Sn, Bi, Pb, Cd and Zn.

Preferably, the sealing liquid contains an insulating and flame-retardant liquid having a freezing point lower than −30 Celsius degree and a decomposition temperature higher than 70 Celsius degree.

The sealing liquid is a cooling liquid having insulating and flame-retardant properties, the freezing point is lower than −30 Celsius degree, and the decomposition temperature is higher than 70 Celsius degree.

According to an embodiment of the present application, the above-mentioned sealing liquid contains an insulating and flame-retardant liquid having a freezing point lower than −30 Celsius degree and a boiling point higher than 70 Celsius degree.

Preferably, the sealing liquid is at least one selected from silicone oil, transformer oil, chlorofluorocarbons, fluorohydrocarbon, chlorohydrocarbon and hydrofluoroether. The above materials for the sealing liquid have preferable insulating property and preferable stability.

According to an embodiment of the present application, the phase-transition temperature of the coolant is in the range from 70 to 150 Celsius degree.

Preferably, the coolant is at least one selected from water and aqueous solution. Preferably, the aqueous solution is selected from aqueous solution of alcohol. Further, the alcohol is at least one selected from ethylene glycol, 1,2-ethylidene glycol, propylene glycol, 1,3-butanediol, hexalene glycol, diethylene glycol, and propanetriol. The above aqueous solutions can reduce the freezing point and improve the working performance at low temperature environment.

Preferably, the coolant is at least one selected from chlorofluorocarbons, fluorohydrocarbon, chlorohydrocarbon, and hydrofluoroether. The above materials for the coolant can be vaporized quickly and have preferable vaporization latent heat to take away a sufficient amount of heat.

Preferably, the cooling pipe is at least partially immersed in the sealing liquid.

In order to ensure the coolant can be discharged out from the cooling pipe smoothly to cool down the battery module after the cooling pipe is melt to form a breach, the hydraulic pressure of the coolant is higher than the hydraulic pressure of the sealing liquid.

The cooling pipe can be a blind pipe having one end being sealed and the other end being open. Or, the cooling pipe can be a through pipe having two ends being open. When using a blind pipe, the coolant does not work during normal operation of the battery; once thermal runaway occurs, the coolant flows out from the cooling pipe for purpose of cooling down and controlling the propagation of thermal runaway. When using a through pipe, the coolant can further take the role to conduct heat through external circulation.

Preferably, the battery module is placed upside down in the battery box, such that the electrode tabs of the battery module are immersed in the sealing liquid.

The battery module is placed upside down, which means the electrode tabs of the battery cells are disposed downwards, such that the electrode tabs can be immersed in the sealing liquid when using a small amount of sealing liquid. For a battery cell, the heat generation of the electrode tabs is relatively large. By using the sealing liquid to dissipate heat from the electrode tabs, the heat dissipating effect is better, and it is helpful to insulate the battery module.

According to another embodiment of the present application, a heat conduction device is attached to an outer wall of the cooling pipe, such that the heat of the battery module can be transferred to the cooling pipe more easily. If thermal runaway happens to a particular battery cell, the heat conduction device can rapidly transfer the heat to the cooling pipe to cause the cooling pipe to melt and form a breach, whereby the coolant is discharged out to control the temperature of the battery module and inhibit the propagation of thermal runaway.

For pouch cells, the packing position of the electrode tabs is relatively easy to break, and the active materials inside the battery may leak out from the break. Placing the battery cells upside down is helpful to reduce the exposure time of leaked materials in the air. Once leakage happens, the active materials flow into the sealing liquid quickly, thereby improving the safety of the battery.

According to the object of the present application, when thermal runaway occurs, the cooling pipe is melt to form a breach, the coolant flows into the battery box. When the temperature reaches the boiling point of the coolant, the coolant begins to undergo phase change and absorb heat, and the pressure in battery box will rise rapidly. In order for the coolant to undergoing phase change rapidly and absorbing more heat, and for the safety of the whole battery pack, the battery box is installed with a pressure relief valve, preferably, a one-way pressure relief valve, such that air generated due to phase change of the coolant can be discharged quickly after reaching a specific pressure, to thereby improve the safety performance.

Preferably, the battery box is provided with an outlet and an inlet, and two open ends of the cooling pipe are respectively connected to the outlet and the inlet.

The heat inside the battery box can be taken away as the coolant flows along the cooling pipe, to realize thermal management during normal operation of the battery. On the other hand, once thermal runaway occurs and the cooling pipe is melt to form a breach, a large amount of the coolant can enter from the inlet to cool down the battery module rapidly.

According to another embodiment of the present application, the outlet and the inlet are located above the liquid level of the sealing liquid.

By setting the outlet and the inlet above the liquid level of the sealing liquid, the sealing liquid in the battery box is avoided to flow into the circulation system through the outlet after the cooling pipe is melt, and meanwhile, more coolant can be contained in battery box to facilitate cooling of the battery module.

As another preferable embodiment, the battery box is provided with an inlet, the open end of the cooling pipe is connected to the inlet, the cooling pipe is disposed in the battery box, and the other end of the cooling pipe is hermetically sealed.

In this way, the coolant in the cooling pipe does not circulate. However, after the cooling pipe is melt to form a breach, a large amount of the coolant is guided into the battery box from the storage tank to cool down the battery pack and prevent further propagation of thermal runaway.

The present application further provides a battery pack system which includes the above-mentioned battery pack. The battery pack system further includes a storage tank, and the storage tank is connected to the battery box through pipeline. The storage tank is filled with the coolant, and the storage tank is connected to the inlet, or to the outlet and the inlet through pipeline.

Due to the limitation of capacity of the cooling pipe, a large amount of the coolant can be stored in the storage tank. The coolant in the cooling pipe can circulate during normal operation to take away the heat of the sealing liquid, for cooling down the battery pack. When thermal runaway is going to happen or has happened in the battery module, the demand for heat dissipating increases dramatically. The cooling pipe is melt to form a breach due to reaching the preset temperature, a large amount of the coolant enters into the battery box to cool down the battery module rapidly, to prevent propagation of thermal runaway.

According to an embodiment of the present application, the storage tank can connect to a plurality of (at least two) battery packs through pipeline. On the same electric vehicle, the possibility of thermal runaway in multiple battery packs at the same time is relatively small, if the particular battery pack having occurring thermal runaway is under control, it can avoid propagation of thermal runaway to other battery packs. Therefore, by sharing a storage tank between multiple battery packs can save the interior space of a vehicle, reduce the weight of whole battery pack system, improve the energy density of the whole battery pack system, and meanwhile, meet the demand for stopping propagation of thermal runaway.

As another preferable embodiment of the present application, when thermal runaway occurs in a single battery pack, the coolant is injected into the battery box from the storage tank. If the temperature in the battery box cannot be controlled quickly, the coolant in other normal battery boxes is also injected into the battery box to obtain a better effect of temperature control.

In accordance with the technical schemes provided by the present application, the temperature of the battery module is more uniform to thereby reduce local accumulation of temperature. When thermal runaway occurs locally, the sealing liquid ensures no open flame generated firstly and the heat generation is reduced after the thermal runaway; in the meantime, the cooling pipe is melt to form a breach after absorbing heat to release the coolant. The coolant undergoes phase change to absorb heat and effectively control the temperature of the battery module, such that the temperature in the battery pack is under control to inhibit propagation of thermal runaway, whereby the loss is minimized. By sharing a storage tank between multiple battery packs can save the interior space of a vehicle, reduce the weight of whole battery pack system, improve the energy density of the whole battery pack system, and meanwhile, meet the demand for stopping propagation of thermal runaway.

### BRIEF DESCRIPTION OF THE DRAWINGS

FIG. 1 is a schematic view of embodiment 1, 2, 3 of the present application;

FIG. 2 is a schematic view of embodiment 4 of the present application;

FIG. 3 is a schematic view of embodiment 5, 6 of the present application;

FIG. 4 is a schematic view of embodiment 7 of the present application;

FIG. 5 is a schematic view of embodiment 8, 9 of the present application;

FIG. 6 is a schematic view of embodiment 7 of the present application;

FIG. 7 is a schematic view of embodiment 8, 9 of the present application;

battery box 1, cooling pipe 11, cooling pipe A 111, cooling pipe B 112, inlet 12, outlet 13, sealing liquid 14, heat conduction device 15, battery module 2, storage tank 3.

### DETAILED DESCRIPTION OF PREFERRED EMBODIMENTS

### Embodiment 1

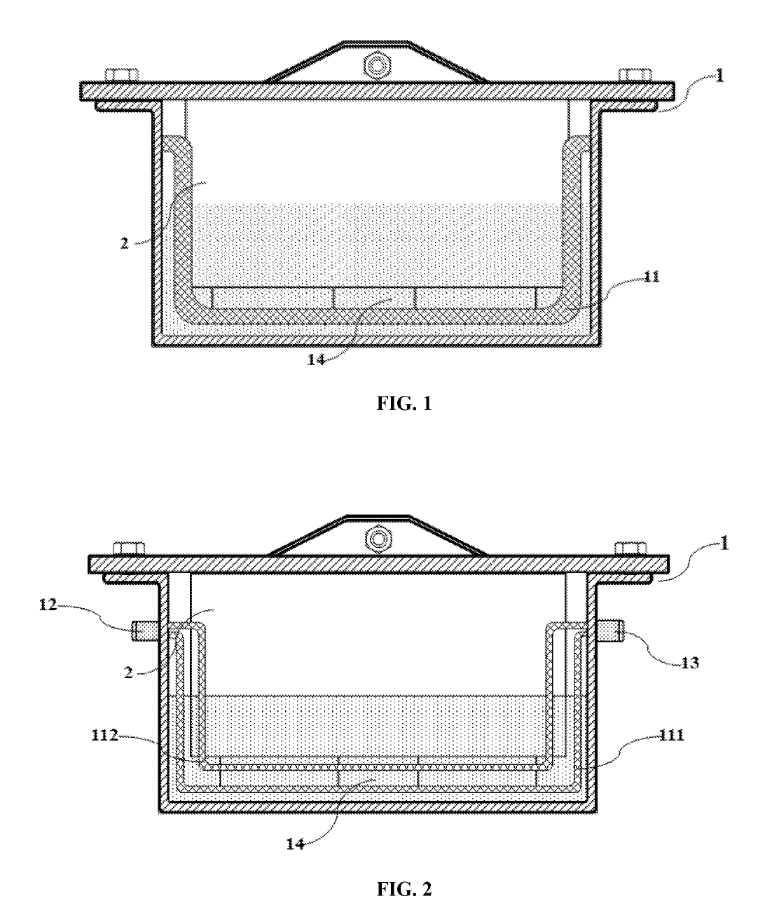

Referring to FIG. 1, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is silicone oil.

A cooling pipe 11 is disposed in the battery box 1, and the cooling pipe 11 is filled with a coolant. The melting temperature of sidewall of the cooling pipe 11 is at a preset temperature, and the preset temperature is 70 Celsius degree. The cooling pipe 11 is used for cooling purpose during normal operation of the battery module 2. The coolant is water.

When thermal runaway happens in the battery module 2, local temperature rises rapidly, the cooling pipe 11 reaches the preset temperature and is melt to form a breach, a large amount of the coolant flows out from the breach to absorb heat by phase change and control the temperature rise of the battery module 2.

### Embodiment 2

Referring to FIG. 1, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is silicone oil.

A cooling pipe 11 is disposed in the battery box 1, and the cooling pipe 11 is filled with a coolant. The melting temperature of sidewall of the cooling pipe 11 is at a preset temperature, and the preset temperature is 70 Celsius degree. The cooling pipe 11 is used for cooling purpose during normal operation of the battery module 2. The coolant is fluorohydrocarbon.

When thermal runaway happens in the battery module 2, local temperature rises rapidly, the cooling pipe 11 reaches the preset temperature and is melt to form a breach, a large amount of the coolant flows out from the breach to absorb heat by phase change and control the temperature rise of the battery module 2.

### Embodiment 3

Referring to FIG. 1, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is hydrofluoroether.

A cooling pipe 11 is disposed in the battery box 1, and the cooling pipe 11 is filled with a coolant. The melting temperature of sidewall of the cooling pipe 11 is at a preset temperature, and the preset temperature is 100 Celsius degree. The cooling pipe 11 is used for cooling purpose during normal operation of the battery module 2. The coolant is ethylene glycol aqueous solution.

When thermal runaway happens in the battery module 2, local temperature rises rapidly, the cooling pipe 11 reaches the preset temperature and is melt to form a breach, a large amount of the coolant flows out from the breach to absorb heat by phase change and control the temperature rise of the battery module 2.

### Embodiment 4

Referring to FIG. 2, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is silicone oil.

A cooling pipe A111 and a cooling pipe B112 are disposed in the battery box 1. The cooling pipe A111 and the cooling pipe B112 are filled with a coolant. The melting temperature of sidewalls of the cooling pipe A111 and the cooling pipe B112 is at a preset temperature, and the preset temperature is 130 Celsius degree. The cooling pipe 11 is used for cooling purpose during normal operation of the battery module 2.

The battery box 1 is provided with an outlet 13 and an inlet 12. The cooling pipe A111 and the cooling pipe B112 are respectively connected to the outlet 13 and the inlet 12. The coolant is circulated in the cooling pipe A111 and the cooling pipe B112 to take away the heat of the sealing liquid 14 to avoid heat accumulation in the battery box 1 to cause damage to the battery box 2. The coolant is stored in a storage tank located outside the battery box. The coolant is water.

When thermal runaway happens in the battery module 2, local temperature rises rapidly, the cooling pipe A111 and/or the cooling pipe B112 reaches the preset temperature and is melt to form a breach, a large amount of the coolant flows out from the breach to absorb heat by phase change and control the temperature rise of the battery module 2.

### Embodiment 5

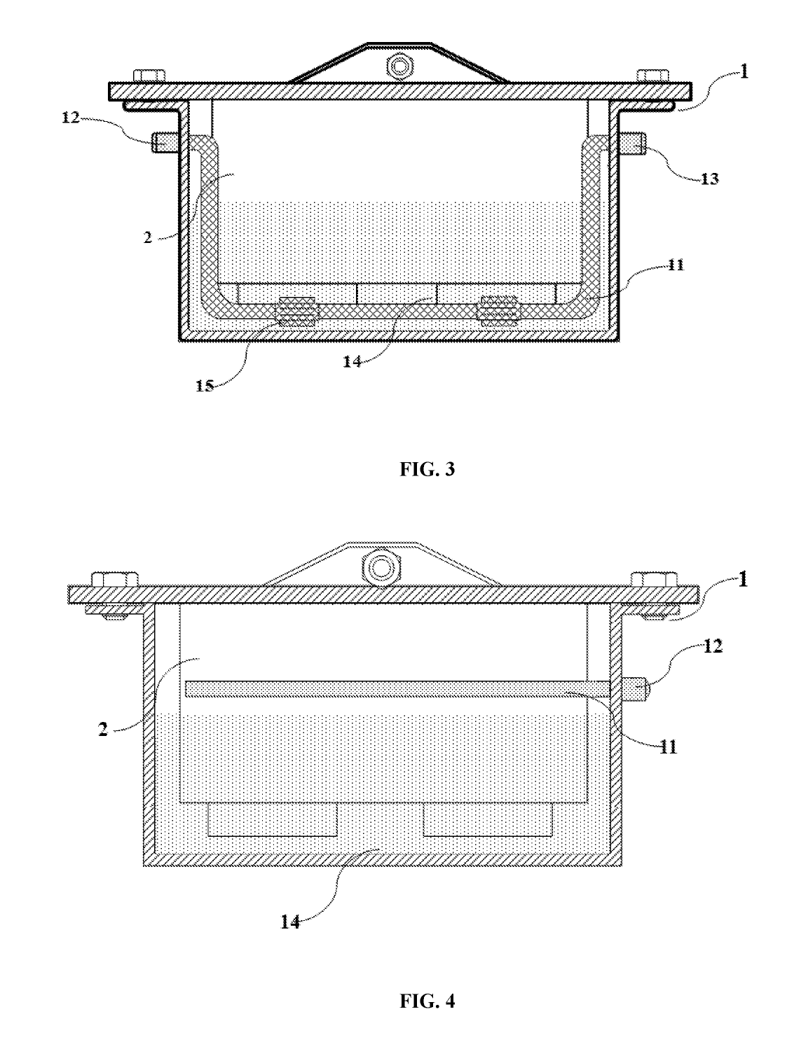

Referring to FIG. 3, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is silicone oil.

A cooling pipe 11 is disposed in the battery box 1, and the cooling pipe 11 is filled with a coolant. The melting temperature of sidewall of the cooling pipe 11 is at a preset temperature, and the preset temperature is 130 Celsius degree. The cooling pipe 11 is used for cooling purpose during normal operation of the battery module 2. A heat conduction device 15 is attached to an outer wall of the cooling pipe 11. In the present embodiment, heat conduction fins are used as the heat conduction device 15.

The battery box 1 is provided with an outlet 13 and an inlet 12. The cooling pipe 11 is connected to the outlet 13 and the inlet 12. The coolant is circulated in the cooling pipe 11 to take away the heat of the sealing liquid 14 to avoid heat accumulation in the battery box 1 to cause damage to the battery box 2. The coolant is stored in a storage tank located outside the battery box 1. The coolant is water.

When thermal runaway happens in the battery module 2, local temperature rises rapidly, the cooling pipe 11 reaches the preset temperature and is melt to form a breach, a large amount of the coolant flows out from the breach to absorb heat by phase change and control the temperature rise of the battery module 2.

### Embodiment 6

Referring to FIG. 3, the present application provides a battery pack which includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is hydrofluoroether.

A cooling pipe 11 is disposed in the battery box 1, and the cooling pipe 11 is filled with a coolant. The melting temperature of sidewall of the cooling pipe 11 is at a preset temperature, and the preset temperature is 200 Celsius degree. The cooling pipe 11 is used for cooling purpose during normal operation of the battery module 2. A heat conduction device 15 is attached to an outer wall of the cooling pipe 11. In the present embodiment, heat conduction fins are used as the heat conduction device 15.

The battery box 1 is provided with an outlet 13 and an inlet 12. The cooling pipe 11 is connected to the outlet 13 and the inlet 12. The coolant is circulated in the cooling pipe 11 to take away the heat of the sealing liquid 14 to avoid heat accumulation in the battery box 1 to cause damage to the battery box 2. The coolant is stored in a storage tank located outside the battery box 1. The coolant is ethylene glycol aqueous solution.

When thermal runaway happens in the battery module 2, local temperature rises rapidly, the cooling pipe 11 reaches the preset temperature and is melt to form a breach, a large amount of the coolant flows out from the breach to absorb heat by phase change and control the temperature rise of the battery module 2.

### Embodiment 7

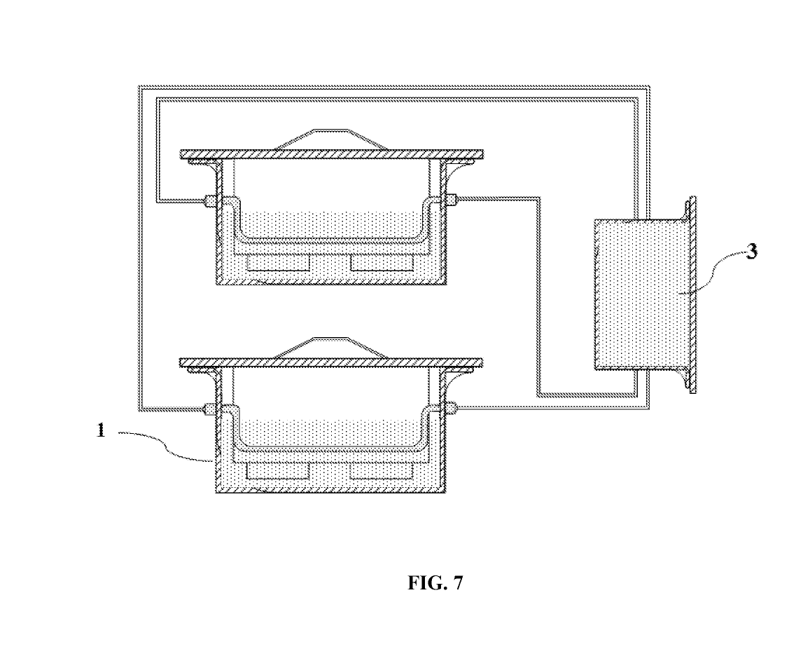

Referring to FIG. 6, the present application provides a battery pack system which includes two battery packs as shown in FIG. 4 and a storage tank 3. The battery pack includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is hydrofluoroether.

A cooling pipe 11 is disposed in the battery box 1. The melting temperature of sidewall of the cooling pipe 11 is at a preset temperature, and the preset temperature is 70 Celsius degree. The battery box 1 is provided with an inlet 12. The cooling pipe 11 is a blind pipe having one end being open and the other end being sealed. The open end of the cooling pipe 11 is connected to the inlet 12. The coolant is ethylene glycol aqueous solution.

A storage tank 3 is provided outside the battery box 1, and the storage tank 3 is filled with the coolant. The storage tank 3 is connected to the battery box 1 through pipeline, and is connected to the cooling pipe 11.

When thermal runaway happens in the battery module 2, local temperature rises rapidly, the cooling pipe 11 reaches the preset temperature and is melt to form a breach. The coolant in the storage tank 3 flows into the battery box 1 through the inlet 12 to absorb heat by phase change and control the temperature rise of the battery module 2.

### Embodiment 8

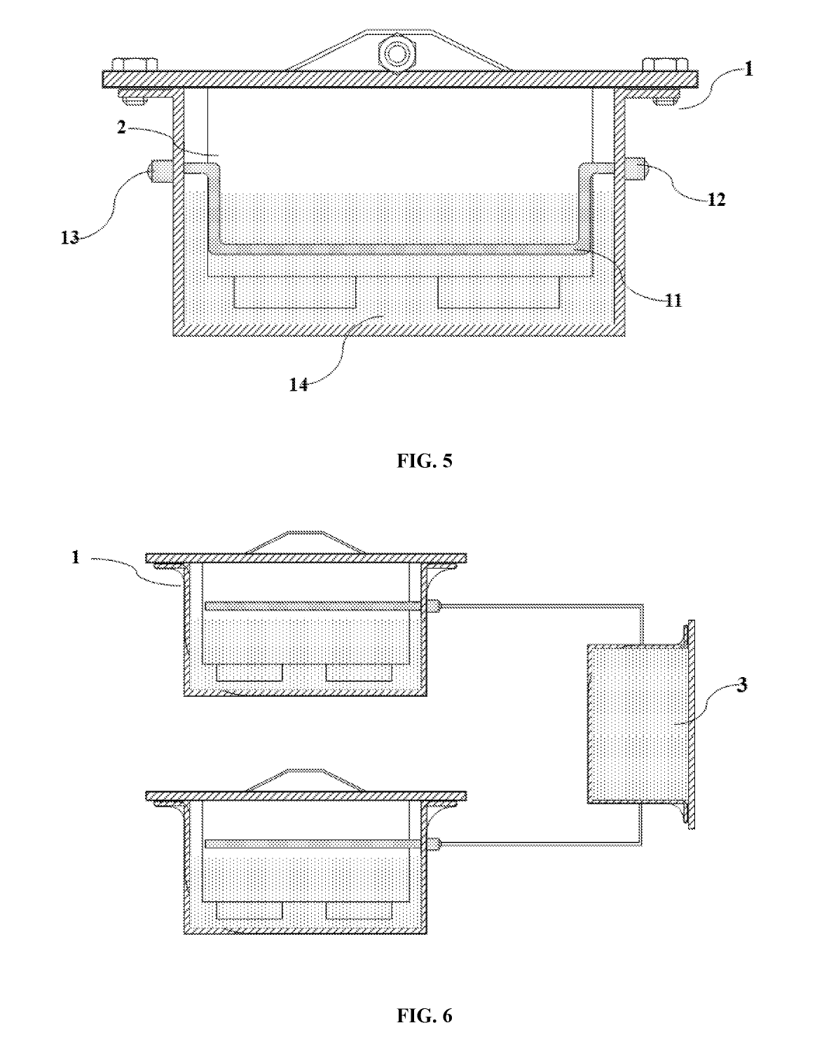

Referring to FIG. 7, the present application provides a battery pack system which includes two battery packs as shown in FIG. 5 and a storage tank 3. The battery pack includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is hydrofluoroether.

A cooling pipe 11 is disposed in the battery box 1. The melting temperature of sidewall of the cooling pipe 11 is at a preset temperature, and the preset temperature is 100 Celsius degree. The battery box 1 is provided with an outlet 13 and an inlet 12. The cooling pipe 11 is connected to the outlet 13 and the inlet 12. The coolant is circulated in the cooling pipe 11 to take away the heat of the sealing liquid 14 to avoid heat accumulation in the battery box 1 to cause damage to the battery box 2. The coolant is ethylene glycol aqueous solution.

A storage tank 3 is provided outside the battery box 1, and the storage tank 3 is filled with the coolant. The storage tank 3 is connected to the battery box 1 through pipeline, and is connected to the cooling pipe 11. The coolant in the storage tank 3 flows along the pipeline, then flows into the cooling pipe 11 through the inlet 12, then flows out from the outlet 13, and finally flows back to the storage tank 3 through the pipeline, to thereby form a complete coolant circulation.

When thermal runaway happens in the battery module 2, local temperature rises rapidly, the cooling pipe 11 reaches the preset temperature and is melt to form a breach. The coolant in the storage tank 3 flows into the battery box 1 through the inlet 12 to absorb heat by phase change and control the temperature rise of the battery module 2.

### Embodiment 9

Referring to FIG. 7, the present application provides a battery pack system which includes two battery packs as shown in FIG. 5 and a storage tank 3. The battery pack includes a battery box 1 and a battery module 2. The battery module 2 is disposed in the battery box 1. The battery box 1 is further filled with a sealing liquid 14, and the battery module 2 is immersed in the sealing liquid 14. The electrode tabs of battery cells are disposed downwards such that the electrode tabs of the battery module 2 are immersed into the sealing liquid 14. The sealing liquid 14 in the present embodiment is hydrofluoroether.

A cooling pipe 11 is disposed in the battery box 1. The melting temperature of sidewall of the cooling pipe 11 is at a preset temperature, and the preset temperature is 100 Celsius degree. The battery box 1 is provided with an outlet 13 and an inlet 12. The cooling pipe 11 is connected to the outlet 13 and the inlet 12. The coolant is circulated in the cooling pipe 11 to take away the heat of the sealing liquid 14 to avoid heat accumulation in the battery box 1 to cause damage to the battery box 2. The coolant is ethylene glycol aqueous solution.

A storage tank 3 is provided outside the battery box 1, and the storage tank 3 is filled with the coolant. The storage tank 3 is connected to the battery box 1 through pipeline, and is connected to the cooling pipe 11. The coolant in the storage tank 3 flows along the pipeline, then flows into the cooling pipe 11 through the inlet 12, then flows out from the outlet 13, and finally flows back to the storage tank 3 through the pipeline, to thereby form a complete coolant circulation.

When thermal runaway happens in the battery module 2, local temperature rises rapidly, the cooling pipe 11 reaches the preset temperature and is melt to form a breach. The coolant in the storage tank 3 flows into the battery box 1 through the inlet 12 to absorb heat by phase change and control the temperature rise of the battery module 2.

1. A battery pack comprising a battery box and a battery module, the battery module being disposed in the battery box, the battery module consisting of a plurality of battery cells, wherein the battery box is further filled with a sealing liquid, the battery module is at least partially immersed in the sealing liquid, at least one cooling pipe is disposed in the battery box, at least a portion of the cooling pipe is configured to melt and form a breach after reaching a preset temperature, the cooling pipe is filled with a coolant, the vaporization latent heat of the coolant is higher or equal to the heat capacity or the vaporization latent heat of the sealing liquid.

2. The battery pack of claim 1, wherein the preset temperature is lower than the temperature of thermal runaway of the battery module.

3. The battery pack of claim 1, wherein the preset temperature is in the range from 70 to 150 Celsius degree.

4. (canceled)

5. The battery pack of claim 1, wherein a material of the portion of the cooling pipe, configured to melt and form a breach, is selected from an alloy with low melting point or a polymer with low melting point.

6. The battery pack of claim 5, wherein the polymer with low melting point is at least one selected from POE, EVA, ABS, PU, PA and CPVC.

7. The battery pack of claim 5, wherein the alloy with low melting point is at least one selected from Ga, In, Sn, Bi, Pb, Cd and Zn.

8. The battery pack of claim 1, wherein the sealing liquid contains an insulating and flame-retardant liquid having a freezing point lower than −30 Celsius degree and a decomposition temperature higher than 70 Celsius degree.

9. The battery pack of claim 8, wherein the sealing liquid is at least one selected from silicone oil, transformer oil, chlorofluorocarbons, fluorohydrocarbon, chlorohydrocarbon and hydrofluoroether.

10. The battery pack of claim 1, wherein the phase-transition temperature of the coolant is in the range from 70 to 150 Celsius degree.

11. The battery pack of claim 10, wherein the coolant is at least one selected from water and aqueous solution.

12. The battery pack of claim 11, wherein the aqueous solution is selected from aqueous solution of alcohol.

13. The battery pack of claim 12, wherein the alcohol is at least one selected from ethylene glycol, 1,2-ethylidene glycol, propylene glycol, 1,3-butanediol, hexalene glycol, diethylene glycol, and propanetriol.

14. The battery pack of claim 10, wherein the coolant is at least one selected from chlorofluorocarbons, fluorohydrocarbon, chlorohydrocarbon, and hydrofluoroether.

15. The battery pack of claim 1, wherein the cooling pipe is at least partially immersed in the sealing liquid.

16. The battery pack of claim 1, wherein the hydraulic pressure of the coolant is higher than the hydraulic pressure of the sealing liquid.

17. The battery pack of claim 1, wherein the battery module is placed upside down in the battery box.

18. The battery pack of claim 1, wherein the battery box is installed with a pressure relief valve.

19. The battery pack of claim 1, wherein a heat conduction device is attached to an outer wall of the cooling pipe.

20. The battery pack of claim 1, wherein the battery box is provided with an outlet and an inlet, two open ends of the cooling pipe are respectively connected to the outlet and the inlet, a storage tank is further provided, the storage tank is filled with the coolant, and the storage tank is connected to the inlet and the outlet through pipeline.

21. The battery pack of claim 1, wherein the battery box is provided with an inlet, one open end of the cooling pipe is connected to the inlet, and the other end of the cooling pipe is hermetically sealed, a storage tank is further provided, the storage tank is filled with the coolant, and the storage tank is connected to the inlet through pipeline.

22. (canceled)

23. (canceled)

24. (canceled)
